(19) United States
(12) Patent Application Publication
(10) Pub. No.: US 2016/0270580 A1
(43) Pub. Date: Sep. 22, 2016

(54) DEVICE AND METHOD FOR BREWING A BEVERAGE

(71) Applicant: CONOPCO, INC., D/B/A UNILEVER, Englewood Cliffs, NJ (US)

(72) Inventor: Richard SMITH, Sandy (GB)

(73) Assignee: Conopco, Inc., d/b/a UNILEVER, Englewood Cliffs, NJ (US)

(21) Appl. No.: 15/036,928

(22) PCT Filed: Nov. 18, 2014
(86) PCT No.: PCT/EP2014/074878

§ 371 Date: May 16, 2016

(30) Foreign Application Priority Data
Nov. 22, 2013 (EP) 13194138.7

(51) Int. Cl. A47J 31/06; A47J 31/40

(52) U.S. Cl. CPC A47J 31/0642; A47J 31/0615; A47J 31/407

(57) ABSTRACT

A capsule holder (20) for receiving a capsule (30) containing tea material, adapted for use with an automated beverage brewing device, the holder comprising a filter (25) for permitting the passage of prepared beverage but preventing the passage of unwanted coarse solid tea material, an inlet for receiving infused beverage above the filter, a means for supporting a capsule within the capsule holder, a chamber (70) beneath the filter (25) into which strained beverage passes during use, the chamber (70) having an outlet (21, 29) for dispensing the prepared beverage, characterised in that, the chamber (70) and the space above the filter (25) are in gaseous communication by means of at least one channel (27, 76).

### TECHNICAL FIELD OF THE INVENTION

The present invention relates to a device and a method for brewing a beverage. In particular, the invention relates to infused tea-based beverages that are brewed in a device having an infusion chamber.

### BACKGROUND TO THE INVENTION

Beverages such as tea and coffee are usually prepared in the home using ground coffee, tea bags or loose-leaf tea. However, the long brewing time required and the mess that is produced are inconvenient. Therefore brewing devices have been devised which provide a convenient, rapid and consumer-friendly way of brewing such beverages.

The beverage material is typically provided in a single use capsule or other container which is disposed of after brewing the beverage. For coffee beverages the capsule itself typically functions as the brewing chamber. The volume of the capsule is normally less than that of the final beverage, so it is necessary for the brewing water to flow through the capsule. This is achieved by having a filter in the capsule so that the brewed beverage can be dispensed whilst the beverage material is retained, and is disposed of together with the capsule.

This method, however, is not well-suited for brewing tea, as tea leaves require a larger volume in which to infuse. Therefore devices for brewing tea have been designed which have a separate, larger infusion chamber.

For example, WO2007/042485 discloses a device for preparing an infused beverage, having an infusion container for containing liquid. A cartridge containing tea leaves is introduced into a cavity in the device. The bottom part of the cartridge comprises a liquid-permeable filter. The infusion container and the cavity communicate with each other, so that when liquid is poured into the infusion container it flows to the cartridge. The tea leaves are thus immersed in the liquid and infusion takes place.

After infusion has taken place, a passage communicating with the cavity is opened to let the infused liquid flow from the infusion container through the cavity and through the filter of the cartridge to the passage. The spent tea leaves are collected in the cartridge and are removed from the cavity together with the cartridge. Whilst the infusion chamber allows space for tea leaves to infuse, this method has a number of disadvantages. In particular the cartridge must firstly provide sufficient area for the filter to allow the beverage to be dispensed in a short time once brewing has taken place, and secondly have sufficient volume to contain the spent tea leaves which swell during infusion, typically to around four times their dry volume.

Thus the cartridge has to be relatively large. It also has to be sufficiently strong to support the weight of the spent tea leaves when it is removed from the device. Thus a substantial amount of material (e.g. plastic) is required to make the capsule. Furthermore, the capsule body and filter are typically made from different materials, so the capsule cannot be easily recycled. These are both undesirable from the point of view of cost and also environmental impact. Hence it is an object of the present invention to overcome these disadvantages.

Another major problem with such a machine is that the swollen tea leaves tend to block the filter during the beverage dispensing stage and can prevent the beverage from dispensing.

If the holes of the filter are increased in size this can reduce the problem of filter blocking, however it has been found that an increased level of tea particles then pass through the filter into the consumers beverage, which diminishes the intended purpose of the filter.

Therefore improvements in this area would be highly desirable.

### SUMMARY OF THE INVENTION

It has been found that such filter blocking by the tea leaves is initiated by pressure differences across the filter, which once they are initiated become exacerbated as more tea leaves are driven to block the filter. Thus gas bubbles can exist below the filter even when a quantity of undispensed beverage remains above the filter.

The present inventors have solved this problem by providing a means of equalising the pressure across the filter without compromising the filtration performance.

Thus, in a first aspect, the invention relates to an automated beverage brewing device comprising an infusion chamber, at the base of which is a capsule holder for supporting a capsule comprising infusible material, means for introducing liquid into the capsule so that the liquid and tea material can mix and flow into the infusion chamber so as to brew the beverage; a filter for permitting the passage of infused beverage but preventing the passage of unwanted solid particulate material, a chamber beneath the filter into which strained beverage passes during use, the chamber having an outlet for dispensing the prepared beverage characterised in that, the chamber and the space above the filter are in gaseous communication by means of at least one channel.

In a second aspect, the present invention relates to a capsule holder for receiving a capsule containing tea material, adapted for use with an automated beverage brewing device, the holder comprising a filter for permitting the passage of prepared beverage but preventing the passage of unwanted coarse solid tea material, an inlet for receiving infused beverage above the filter, a means for supporting a capsule within the capsule holder, a chamber beneath the filter into which strained beverage passes during use, the chamber having an outlet for dispensing the prepared beverage, characterised in that, the chamber and the space above the filter are in gaseous communication by means of at least one channel.

It has been found that a channel can be provided which is capable of providing a pressure equalization function that does not compromise the performance of the filter. Tea leaves are largely prevented from entering the at least one channel by ensuring that the channel presents a greater flow resistance to the infused beverage than does the filter.

In a preferred embodiment, the channel presents greater total fluid flow resistance than that provided by the filter.

Thus, as the tea leaves settle downwards during delivery of the brewed beverage, they generally fall towards the filter and pass the channel opening above the filter without entering it. It is believe that this is because the bulk of the infused beverage flow is though the filter, so that the flow path for the tea leaves is towards the filter rather than towards the opening in the channel above the filter.

In a preferred embodiment the at least one channel is dimensioned to be greater than an opening in the filter, whilst still presenting greater total fluid resistance than the filter. In a preferred embodiment the at least one channel has an effective cross sectional diameter of from 0.5 to 4 mm, preferably from 1.0 to 2.0 mm.

Preferably the opening is above the filter surface, to reduce the chance that any tea leaves that were travelling towards the filter get redirected to flow through a channel. Thus, preferably the opening is at least 5 mm above the filter, preferably at least 10 mm above.

Generally, there does not need to be very many channels in order to provide the required pressure equalization. Furthermore, fewer channels increases the fluid resistance provided by the channels as a whole and so is beneficial to the functioning of the device. Thus typically there are no more than five channels, preferably no more than three or even only one channel.

In a further preferred embodiment, the channel opening above the filter is located downstream of the filter surface. Thus, by ensuring that the infused beverage must first flow over the surface of the filter before arriving at the opening of the channel above the filter, there is a further reduced chance that infused beverage and solids may travel along the channel.

Such an arrangement may be achieved by ensuring that the infused beverage flows onto a first side of the filter with the opening of the channel being positioned opposite the first side of the filter.

For example, the presence of the capsule can be employed to direct the infused beverage onto the first side of the filter, whereupon the infused beverage must flow over the filter surface beneath the capsule before reaching the opposite side of the filter surface before reaching the opening of the channel above the filter.

In a preferred embodiment the filter is not located in the capsule but is located in the capsule holder.

In this embodiment, the capsule holder of the invention performs some of the functions performed in the prior art by the capsule, such as filtering the brewed beverage in order to retain the spent tea leaves. Thus the functionality required of the capsule is significantly reduced and the construction of the capsule can be much simpler. For example, the capsule no longer needs to be opened on both sides so it can be a simple, impermeable cup with a foil lid. This of course requires that there is a route for the brewed beverage to pass from the infusion chamber to the filter in the capsule holder. Thus the capsule must not cover the whole of the area inside the upper rim of the capsule holder. Nonetheless, the capsule holder must support the capsule in place during brewing.

The capsule holder comprises means for supporting the capsule. These means support the base and/or the flange of the capsule. These means may comprise one or more protrusions on the inside of the sidewall and/or the base of the capsule holder. For example, there may be a shelf on the inside of the sidewall just below the upper rim of the capsule holder. Alternatively or additionally, there may be ribs, walls or pillars etc which extend upwards from the base.

Alternatively, or additionally, the base itself may be shaped so as to support the capsule. The capsule holder preferably further comprises means for defining the location and orientation of the capsule. The capsule may have rotational symmetry, in which case the means define a number of possible orientations. The means for defining the location and orientation of the capsule may comprise protrusions and/or indentations on the shelf.

Preferably, the means for supporting the capsule consists of a shelf on the inside of the sidewall of the capsule holder. This has the advantage that there are no ribs, walls or other protrusions on the base or sidewall of the capsule holder which would create locations within the capsule holder which could trap tea leaves, and hence be difficult to clean.

Thus, in a third aspect, the invention provides a strainer which is adapted to co-operate with a receptacle to form a capsule holder, the strainer comprising:
a base (73) and a rim (74),
means (28) for supporting a capsule (30) within the strainer, so that the capsule partially covers the area inside the rim, and
a filter (25) situated beneath the intended location of the capsule, and a channel in the rim (74) that provides gaseous communication between the receptacle and the space above the filter when placed on the receptacle.

As used herein the term “tea material” refers to tea plant material, herb plant material or a mixture thereof. For the avoidance of doubt, the term “tea material” does not include coffee material. The term “tea plant material” refers to leaf, bud and/or stem material from Camellia sinensis var. sinensis and/or Camellia sinensis var. assamica. The tea plant material may be substantially fermented (i.e. black tea), partially fermented (i.e. oolong tea) or substantially unfermented (i.e. green tea or white tea). It may also be a blend of one or more of the aforementioned tea plant materials. Other ingredients which are commonly used to flavour leaf tea products may also be combined with the tea plant material (e.g. bergamot, citrus peel and the like). The term “herb plant material” refers to material which is commonly used as a precursor for herbal infusions. Preferably the herb plant material is selected from chamomile, cinnamon, elderflower, ginger, hibiscus, jasmine, lavender, lemongrass, mint, rooibos (obtained from Aspalathus linearis), rosehip, vanilla and verbena. The tea material may additionally comprise fruit pieces (e.g. apple, blackcurrant, mango, peach, pineapple, raspberry, strawberry etc).

Preferably the tea material is dried and has a moisture content of less than 30 wt %, more preferably less than 20 wt % and most preferably from 0.1 to 10 wt %. Preferably the tea material particles have a size (i.e. longest diameter) of from about 2 to about 10 mm, preferably 3 to 7 mm.

The term “beverage” refers to a substantially aqueous drinkable composition which is suitable for human consumption. Preferably the beverage comprises at least 85% water by weight of the beverage, more preferably at least 90% and most preferably from 95 to 99.9%. Preferably the beverage comprises from 0.04 to 3%, more preferably from 0.06 to 2%, most preferably from 0.1 to 1% by weight tea solids.

The term “brewing” refers to the addition of a liquid, particularly hot water, to tea material, so that steeping or soaking the tea material in the liquid releases soluble substances into the liquid (e.g. flavour and/or aroma molecules) thereby to form a beverage. Brewing may be carried out at any temperature, but preferably in the range of 80 to 95° C.

The term “infusion chamber” means a vessel in which infusion of tea material takes place, and which is large enough both to allow the tea material to move around in the liquid during infusion, and also to contain a substantial part (i.e. at least 50%) of the volume of the final beverage. The term “infusion chamber” therefore does not refer to capsules inside which brewing takes place, as is typically the case in coffee machines.

The term “capsule” refers to a rigid or semi-rigid container in which tea material is or may be packaged, for example a capsule, cartridge, pod, or the like.

The term “fluid resistance” means that for a given pressure difference for the same conditions, a channel having greater fluid resistance will provide less volumetric fluid flow than a channel having less fluid resistance.

The term “effective cross-sectional diameter” means the diameter of a notional channel with a circular cross section which has the same fluid resistance as the channel.

The present invention will now be described with reference to the figures, wherein:

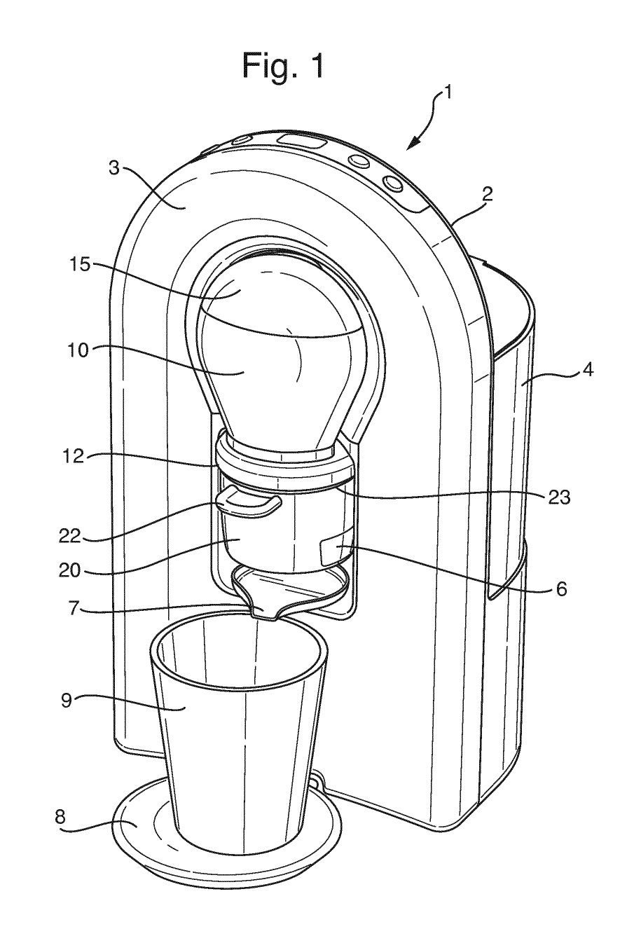

FIG. 1 shows a brewing device according to the invention.

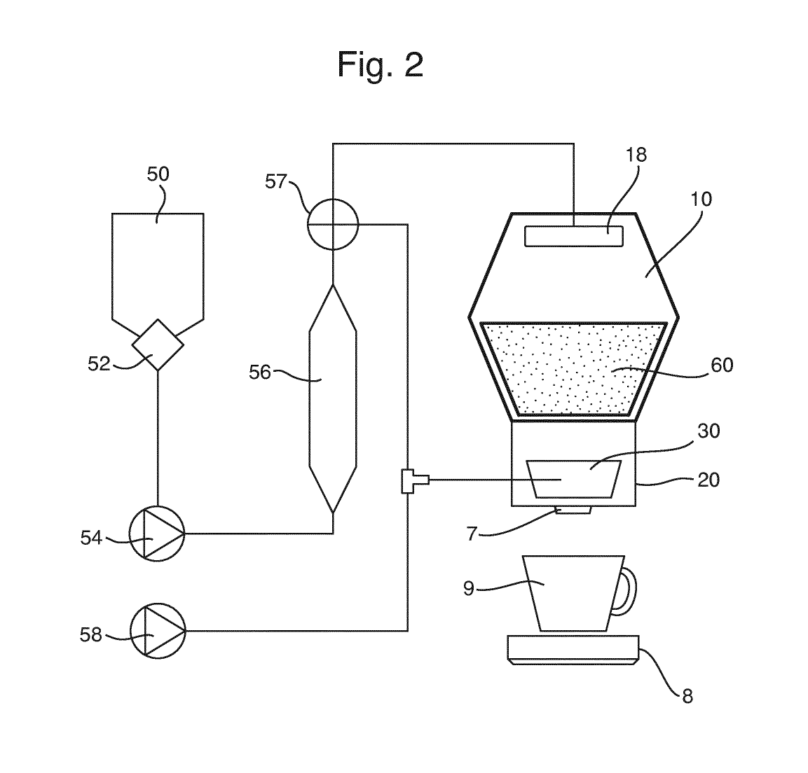

FIG. 2 is a schematic diagram showing the main functional components of the device.

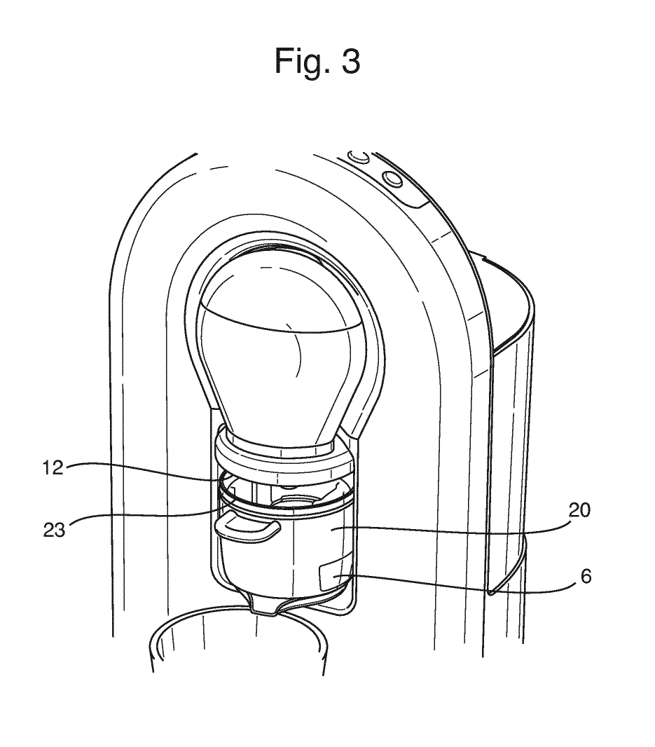

FIG. 3 shows the device of FIG. 1 with the capsule holder in its lowered position.

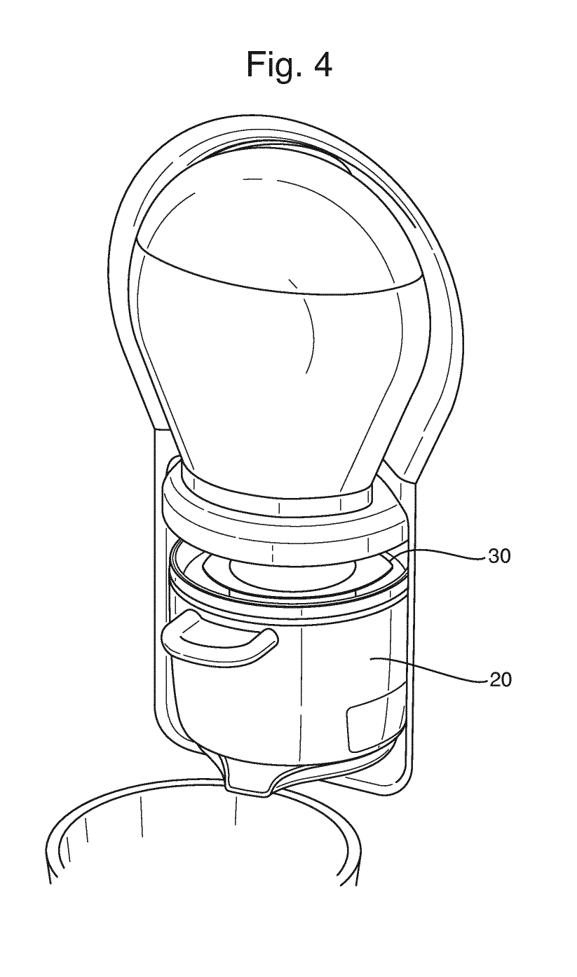

FIG. 4 shows the device as in FIG. 3, now with a capsule inserted into the capsule holder.

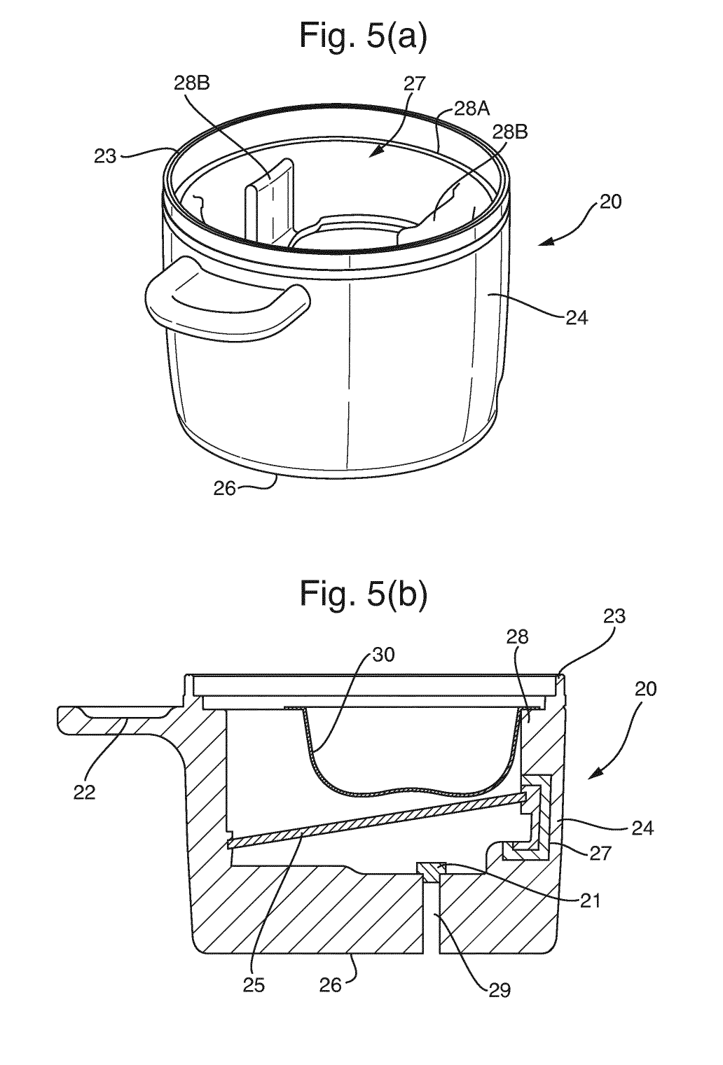

FIG. 5 shows a first embodiment of the capsule holder removed from the device.

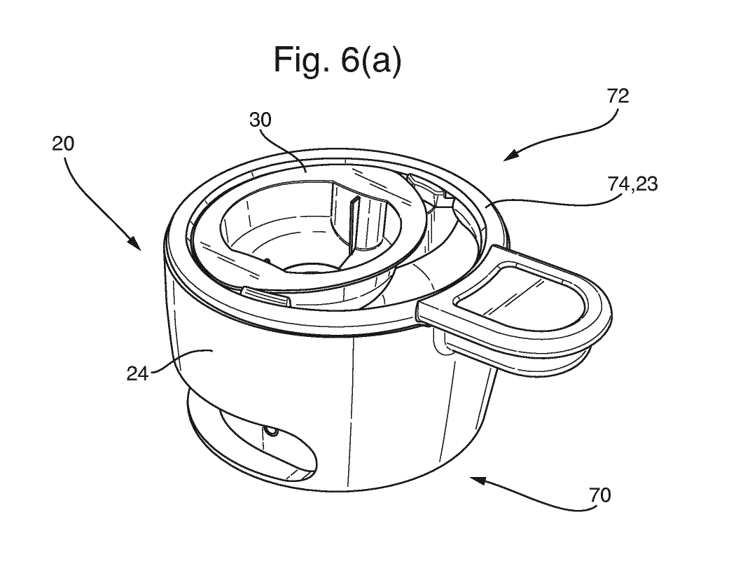

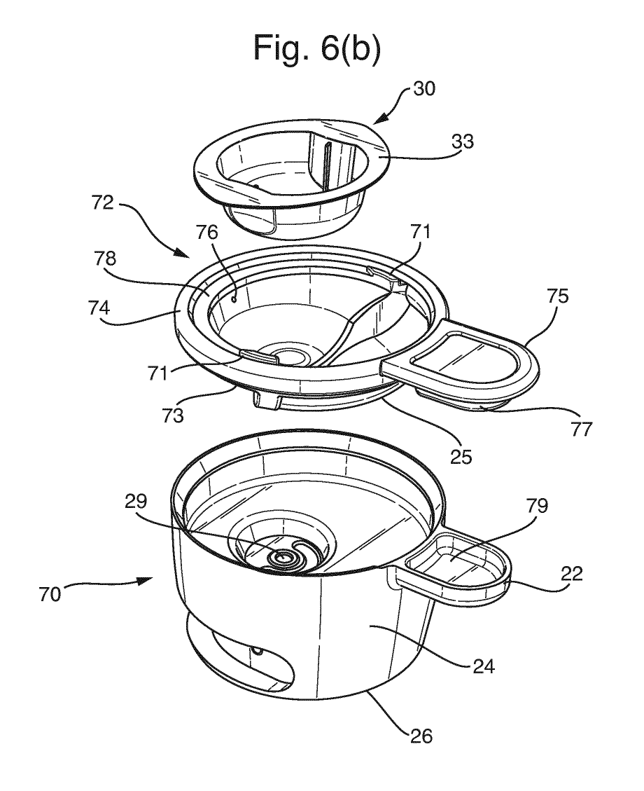

FIG. 6 shows a second embodiment of the capsule holder removed from the device, and containing a capsule.

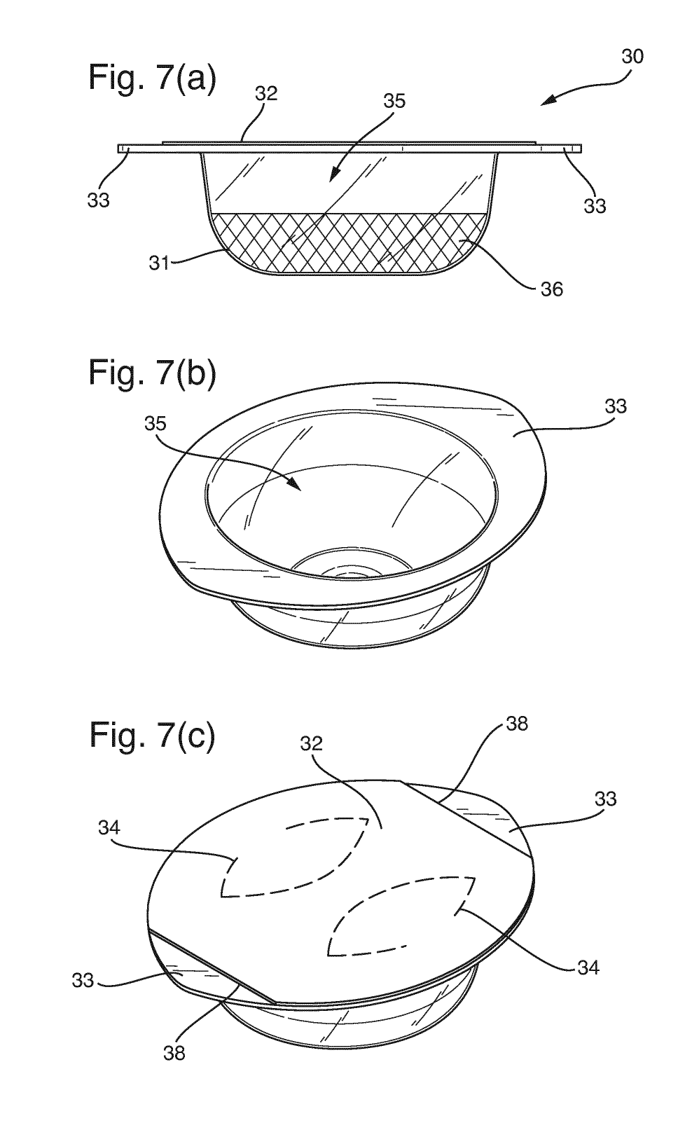

FIG. 7 shows (a) a side view of a capsule (b) a perspective view of a capsule without a lid and (c) with a lid.

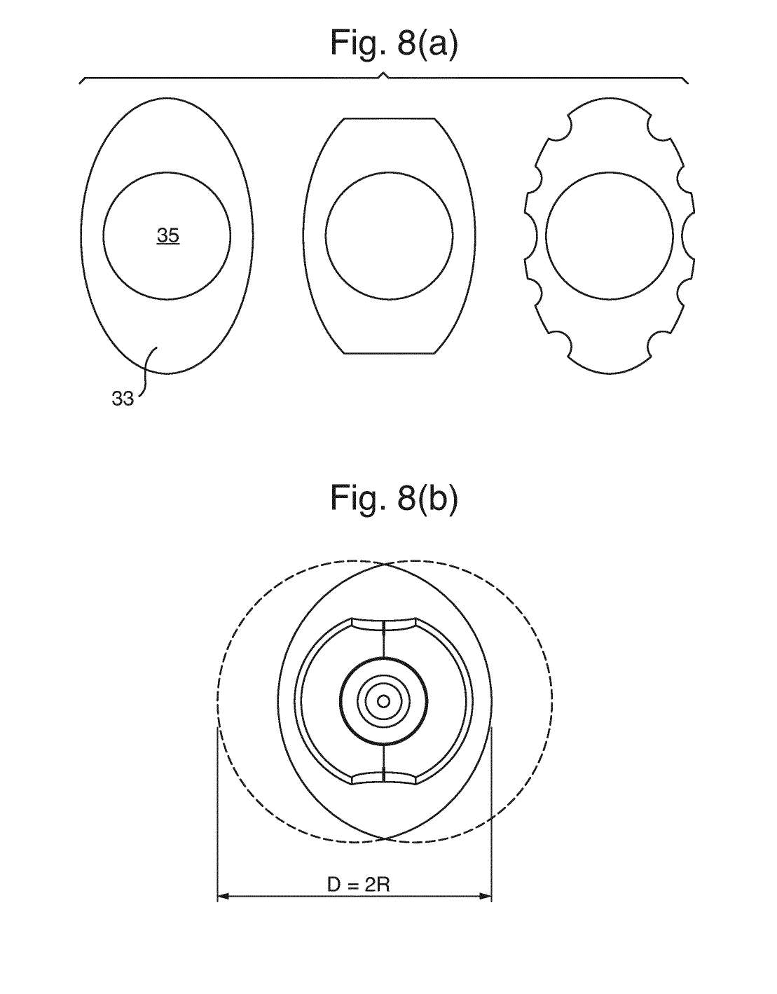

FIG. 8 shows views from above of capsules having various generally elliptical shaped flanges.

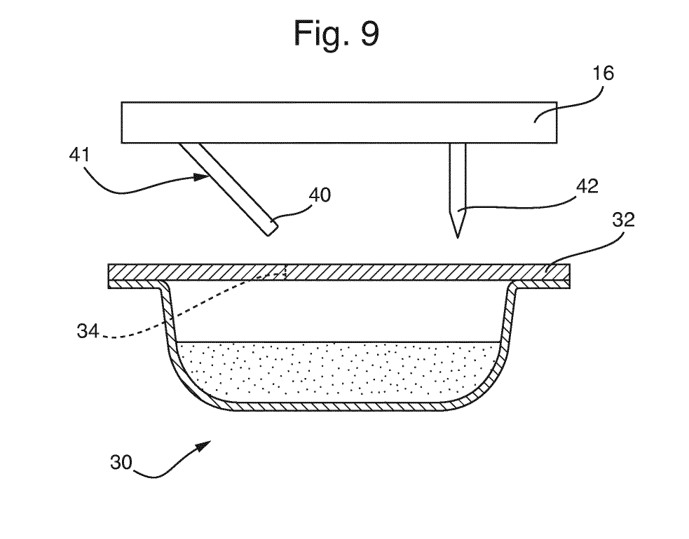

FIG. 9 shows the manifold of the infusion chamber with an opening member for opening the lid of the capsule.

FIG. 1 shows one non-limiting embodiment of a brewing device according to the invention. The device 1 has a casing 2 with a front side 3 and a rear side 4. An infusion chamber 10 and a capsule holder 20 are located at the front side of the device. The infusion chamber 10 has a bottom rim 12 which defines an opening in its lower side. The infusion chamber may have an opening in its top side which is covered with a removable lid 15, or it may be constructed as a vessel without an opening in its top side. The capsule holder 20 is designed to receive a capsule. It is located in a support 6 and preferably has a handle 22. The capsule holder is preferably substantially circular when viewed from above, which provides for easy cleaning since there are no corners in which tea leaves could become trapped.

In FIG. 1, the capsule holder 20 is shown in position for brewing, i.e. so that the upper rim 23 of the capsule holder is in water-tight contact with the bottom rim 12 of the infusion chamber 10. The infusion chamber 10 is supported and held in place by a manifold (not shown). A water reservoir, heater, and pump (not shown) are located inside the rear 4 of the casing. At the bottom of the front side 3 of the casing there is a tray 8 on which a cup 9 is placed when the beverage is dispensed. A dispensing spout 7 is positioned beneath the capsule holder.

FIG. 2 is a schematic diagram showing the main functional components of the device. Water from the reservoir 50 is fed to the infusion chamber 10 via a water filter 52, a water pump 54, a heater 56 and a valve 57. The heater is preferably a flow-through heater. The valve 57 controls the route the water takes between the heater 56 and the infusion chamber 10. For example, the water may firstly be pumped to the infusion chamber 10 via the capsule 30 in order to brew a beverage 60. Subsequently, the valve 57 can re-direct the water such that it enters the brewing chamber 10 via a rinse head 18 in order to rinse and/or clean the brewing chamber 10. There may also be an air pump 58 which can pump air to the infusion chamber, for example via the capsule 30 which is located in the capsule holder 20, or via the capsule holder itself. The spout 7, cup 9 and tray 8 are located beneath the capsule holder 20.

FIG. 3 shows the device of FIG. 1 with the capsule holder 20 lowered so that its upper rim 23 is separated from the bottom rim 12 of the infusion chamber. The capsule holder 20 is preferably removable from the support 6 so that a capsule can be easily inserted and also for ease of cleaning. FIG. 4 shows the device with a capsule 30 inserted into the capsule holder 20, which is in the lowered position.

FIG. 5 shows one embodiment of a capsule holder 20 removed from the device: (a) in a perspective view and (b) in cross-section. The capsule holder 20 has a sidewall 24 with an upper rim 23 and a base 26. The sidewall 24 is preferably circular when viewed from above.

The capsule holder comprises means 28 for supporting a capsule, such that the capsule partially covers the area inside the upper rim. In the embodiment shown in FIG. 5, the means for supporting the capsule 28 consist of a shelf 28A on the inside of the sidewall 24 just below the upper rim 23 and ribs 28B extending upwards from the base 26.

A filter 25 is located inside the capsule holder beneath the capsule. Below the filter 25 is a passage 29 through which the beverage flows during dispensing and which is closed by a drain valve 21 during brewing. The filter preferably consists of a fine mesh made, for example, of stainless steel, nylon, polyester or PTFE. The mesh size must be sufficiently small to catch small pieces of tea material but large enough to ensure that draining is not too slow. Preferably, the mesh size is from 100 to 500 microns, more preferably 150 to 300 microns.

Preferably the filter (when in its normal position in the device) is inclined to the horizontal at an angle of from 5 to 45°, preferably from 10 to 30°, such as about 20°. Having the filter at an angle to the horizontal has two advantages: firstly it presents a larger surface area, and hence increases the speed of draining. Secondly tea material collects at the bottom of the sloped filter while leaving the upper part clear of tea material so that the beverage drains freely through it.

Also provided is a circular cross-section channel 27 which provides gaseous communication between the chamber beneath the filter and the region above the filter. The diameter of the channel being 1.5 mm in diameter is significantly greater than the size of one aperture in the filter. However, as only one channel 27 is provided the volumetric flow rate through the channel 27 will be significantly less than that through the filter under the same conditions during use.

In use, infused beverage is introduced to the filter on the side opposite that to where the opening 27 is located due to the positioning of the capsule 30. Thus, the infused beverage must flow across the entire surface of the filter beneath the capsule 30 before arriving at the opening of the channel 27 above the filter.

In use it has been found that almost no solid tea leaves pass through the channel. This is because the channel provides a pressure equalization across the filter which maintains flow through the filter, keeping the tea leaves dragged towards the filter rather than through the channel 27. Thus, the filter 27 does not get blocked due to any pressure differences.

FIG. 6 shows perspective views of a second embodiment of the capsule holder 20 which consists of two separable parts, a receptacle 70 and a strainer 72. FIG. 6(a) shows the capsule holder when assembled with a capsule 30 in place, and FIG. 6(b) shows the capsule, strainer and receptacle separated.

The receptacle 70 has a sidewall 24 and a base 26. Again, the sidewall is preferably circular when viewed from above. Located in the base 26 is a passage 29 through which the beverage flows during dispensing and which is closed by a drain valve (not shown) during brewing. The receptacle 70 has a handle 22.

The strainer 72 has a base 73, a rim 74 and a handle 75. In the embodiment shown in FIG. 6, the means for supporting the capsule comprise a shelf 78 on the inside of the sidewall 24 just below the rim 74. The shelf 78 extends around part of the sidewall. The capsule 30 has a flange 33 which corresponds to the shape of the shelf, so that the flange rests on the shelf along substantially all of one side of the capsule, and thus is supported by it. The sidewall is preferably circular (when viewed from above), so the shelf similarly has the form of an arc of a circle. This requires the flange of the capsule to be generally elliptical in shape. In contrast, if the capsule had for example a circular flange, the area of contact between the shelf and the flange would not be sufficient to support the capsule.

Hence and extra supports would be required inside the capsule holder. These could result in locations within the capsule holder which could trap tea leaves, and hence be difficult to clean.

It is not essential that the shelf is continuous, provided that it is capable of supporting the flange of the capsule. Thus for example, the shelf could have small gaps. The width of the shelf preferably matches the width of the flange, and is preferably at least 3 mm wide. The part 80 of the flange 33 which rests on the shelf 78 is indicated in FIG. 6(a). Small members 71 on the shelf ensure that the capsule is located in the correct position and in one of the two possible correct orientations.

At least part of the base 73 of the strainer is made up of a filter 25. In the preferred embodiment shown, the part of the base 73 which is located underneath the capsule is solid whilst the rest of the base consists of the filter. The solid part may also serve to support the capsule. The filter preferably consists of a fine mesh made, for example, of stainless steel, nylon, polyester or PTFE. The mesh size must be sufficiently small to catch small pieces of tea material but large enough to ensure that draining is not too slow. Preferably, the mesh size is from 100 to 500 microns, more preferably 150 to 300 microns.

As shown in FIG. 6(a), in use the strainer 72 rests on the receptacle and is supported by the sidewall 24. The rim 74 of the strainer forms the upper rim 23 of the capsule holder 20. The strainer covers the whole of the top of the receptacle 70, so that liquid cannot pass between the rim 74 of the strainer and the sidewall 24 of the receptacle, and hence can only enter the receptacle 70 by passing through the filter. The filter prevents spent tea leaves from entering the receptacle 70. Preferably the rim 74 is made from an elastomeric material. Thereby it is in effect a gasket which forms seals both between the receptacle and the strainer, and also between the capsule holder and the infusion chamber.

This embodiment has the advantage that the strainer and receptacle can be easily separated for cleaning. Moreover, in order to empty out spent tea leaves from the capsule holder, it is only necessary to remove the strainer and tip the spent leaves out from it.

Preferably the handle 75 of the strainer is larger than and overlaps the handle 22 of the receptacle. When the strainer is located in the receptacle, the handle 75 of the strainer sits on top of handle 22 of the receptacle, as shown in FIG. 6(a). This allows the receptacle and strainer to be picked up together, by gripping them from above and below. Nonetheless, the strainer can be easily removed from the receptacle by gripping the edges of its handle 75 where it extends beyond the handle 22 of the receptacle.

The handle 75 of the strainer may optionally have a projection 77 on its lower side, which rests in a corresponding hollow 79 in the top side of the handle 22 of the receptacle. This helps to locate the strainer correctly with respect to the receptacle. The strainer may optionally have a lip (not shown) on its rim, for example located opposite the handle, which rests in a corresponding notch in the top of the sidewall of the receptacle. This helps to locate the strainer correctly with respect to the receptacle, and also to support it.

The strainer 72 also comprises an opening 76 which provides a circular cross-section channel between the receptacle 70 and the region above the filter when assembled. The diameter of the channel being 1.5 mm is significantly greater than the size of one aperture in the filter. However, as only one channel 76 is provided the volumetric flow rate through the channel 76 will be significantly less than that through the filter under the same conditions during use.

In use, infused beverage is introduced to the filter on the side opposite that to where the opening 76 is located due to the positioning of the capsule 30. Thus, the infused beverage must flow across the entire surface of the filter beneath the capsule 30 before arriving at the opening of the channel 76 above the filter.

FIG. 7(a) shows a side view of a capsule 30. The capsule comprises a body part 31 and a lid 32. The body part 31 defines a cavity 35 in which the tea material 36 is placed. The lid is attached to the body part so as to enclose the tea material 36 within the capsule. The functionality required of the capsule is significantly reduced compared to known capsules, because the capsule does not need to contain a filter. The brewing liquid does not need to enter through one side and exit through the other, so there is no need to puncture or otherwise make an opening in the body part of the capsule. Thus the construction of the capsule is greatly simplified. Thus the body part is preferably a single, impermeable piece and preferably does not contain any means (for example a filter, or an openable or weakened area) for allowing liquid to enter or exit the capsule through the body part. The body part is preferably made from plastic or aluminium. It may be formed for example by injection moulding or by thermoforming.

The cavity 35 is preferably generally circular in cross-section, when viewed from above, as shown in FIG. 7(b). This shape is convenient from the point of view of manufacture and also for filling tea material into the capsule. It also facilitates release of the tea material from the capsule during brewing, since there are no corners or other areas where the tea material could become trapped. “Generally circular” does not require that the cavity has an exactly circular cross-section; thus for example it could have small indents, provided that there are no narrow recesses in which tea material could become trapped.

The body part comprises a flange 33, and the lid is attached to the flange, e.g. by heat-sealing, thereby enclosing the tea material. In order to provide sufficient area to attach the lid securely, the flange is preferably at least 3 mm wide. The flange 33 also serves to support the capsule in the capsule holder by resting on the shelf on the inside of the sidewall of the capsule holder, as described above. Thus the flange is shaped and sized to match its intended location in the capsule holder.

The preferred embodiment of the capsule holder described above requires a capsule with a flange which is generally elliptical in shape. “Generally elliptical” does not require that the flange is exactly elliptical. The flange has a radius of curvature that is similar to the radius of the inside of the sidewall 24 of the capsule holder, so that the shape of the flange generally corresponds to the shelf. Nonetheless, small variations from an elliptical shape can be accommodated whilst there is still sufficient overlap between the flange and the shelf to support the capsule. Some examples of generally elliptical shapes are shown in FIG. 8. In a particularly preferred embodiment, the flange of the capsule is defined by two intersecting circular arcs each having a radius of curvature (R) which is substantially the same radius as the capsule holder, i.e. half of the internal diameter (D) of the capsule holder, as shown in FIG. 8(b). The ratio of the longest diameter of the flange to the shortest diameter of the flange is from 1.2:1 to 1.5:1. A minimum ratio of 1.2:1 is required in order to give sufficient space for the brewed beverage to pass by the capsule, and a maximum ratio of 1.5:1 is required so that the capsule is large enough to contain sufficient tea material, without requiring an excessively large capsule holder.

The capsule is preferably symmetrical, and most preferably has 180° rotational symmetry about a vertical axis. Thus the capsule can be placed in the capsule holder in either of two orientations.

In a preferred embodiment, the body part of the capsule is transparent, so that the tea material inside the capsule is visible. This is attractive to the consumer, and also has the advantage that the contents can be inspected for quality control purposes after filling using optical means, rather than, for example, by weight.

The functionality required of the capsule is significantly reduced compared to known capsules which contain a filter. There is no need for the capsule to hold the spent tea leaves, nor does the capsule need to form a water-tight connection with the infusion chamber. In fact, the capsule is immersed in the brewing liquid. Since the capsule only needs to be large enough and strong enough to contain a single serving of the dry tea material it can be much smaller than known capsules. Thus the internal volume of the capsule (i.e. the volume of the cavity) is from 10 to 24 cm³, preferably 12 to 19 cm³, most preferably from 14 to 18 cm³. Moreover, the capsule only needs to be strong enough to support dry tea material, and not wet spent tea material. Thus the body part of the capsule can also have relatively thin walls.

The reduced capsule size means that the amount of material (e.g. plastic) needed to make the capsule is significantly reduced. This has environmental and cost advantages. Furthermore, the capsule body part can be more easily recycled because it is made of a single material, unlike typical capsules having a filter. A small capsule also has the advantage of taking up less space during transport and during storage, for example in a consumer's cupboard.

The cavity must not be so shallow that tea material bounces out of it during filling. Thus the depth of the cavity is preferably at least 10 mm, more preferably at least 13 mm. On the other hand, the cavity must not be so deep that it is difficult to remove the tea material from the capsule at the start of brewing. Thus the depth of the cavity is preferably at most 20 mm, more preferably at most 18 mm. It is easier to remove the tea material from a cavity with a depth in the upper part of this range when the volume of the cavity is also towards the upper end of its range (i.e. when the cavity is not both deep and narrow).

The cross-sectional area and diameter of the cavity are related to the required volume and depth. Consequently, the diameter of the cavity is preferably from 30 to 45 mm. The lid, which overlaps with or covers the flange as well as covering the cavity, is therefore preferably from about 45 to 60 mm in diameter, more preferably 47 to 58 mm. The lid is preferably shaped to generally match the shape of the flange.

The lid can be a simple thin film or foil. The lid is preferably made of a metallic foil or a laminated foil, most preferably a laminate of aluminium foil and polyethylene.

In a preferred embodiment, the shape of the lid is defined by two intersecting circular arcs, but with truncated ends 38, as shown in FIG. 7(c). The length of the lid between the two truncated ends is from 47 to 58 mm, and the maximum width of the lid is from 45 to 50 mm.

Preferably the lid has perforations in order to facilitate opening the capsule to inject water and release the tea material, as will be described below. More preferably the lid 32 has a line of perforations 34 in the form of a curve, with sections which extend backwards from the ends of the curve, as shown in FIG. 7(c). This configuration produces a well-defined opening when the lid is pushed against a blunt opening member (described below), which allows the tea leaves to be released from the capsule. Most preferably there are two sets of perforations in the lid, arranged symmetrically, as shown in FIG. 7(c), so that in whichever of the two possible orientations the capsule is inserted, one set of perforations is always located beneath the opening member. The cut:tie ratio of the perforations should be such that they do not burst too easily, for example during transport, but nonetheless open without requiring too great a force. For example, for an aluminium foil/polyethylene laminate lid, a cut:tie ratio of around 1:2 is suitable.

Typically the capsules are provided to the consumer in air-tight secondary packaging, for example as packs containing a number of capsules (e.g. ten). Having a perforated lid has a further advantage in that some of the tea aroma is released from the tea material inside the capsule into the space inside the secondary packaging. Thus the consumer obtains the aroma of tea on opening the secondary pack.

In use, the device functions as follows. With the capsule holder in its lowered position, the user removes the capsule holder from the support, or in the second embodiment of the capsule holder shown in FIG. 6, the user may just remove the strainer from the receptacle. A capsule containing tea material is placed into the capsule holder so that it rests on the means for supporting the capsule. These means preferably also locate the capsule in the correct position and orientation.

The capsule holder is then replaced on the support. Next the user raises the support, for example by pressing a button on the device which activates an actuator. The capsule holder travels vertically upwards until it connects with the infusion chamber, and forms a water-tight seal. In an alternative embodiment, the infusion chamber could move down towards the capsule holder.

In the context of the present invention, ‘connecting the upper rim of the capsule holder to the bottom rim of the infusion chamber’ and ‘the upper rim is connected to the bottom rim of the infusion chamber’ should be understood to mean that upper rim of the capsule holder and the bottom rim of the infusion chamber form a water-tight contact, so that the capsule holder and infusion chamber form a vessel in which the brewing liquid can be held while brewing takes place. The capsule holder and infusion chamber may be connected by means of an intermediate member such as a gasket (for example a ring made of rubber or other compliant material located on the upper rim of the capsule holder and/or the bottom rim of the infusion chamber) in order to provide a good seal. The infusion chamber and the capsule holder form a space for brewing when connected. Preferably the volume of the space for brewing is at least 75%, more preferably at least 90% of the volume of the final beverage.

In a preferred embodiment, shown in FIG. 9, the lid is opened by pushing it against one or more static opening members when the capsule holder travels upwards to connect with the bottom rim of the infusion chamber. The lid 32 is pushed against a static opening member 40 located on the infusion chamber manifold 16. The function of the member is to create an opening in the lid in order to release liquid and tea material. This can be achieved by a member with a sharp edge which cuts or punctures the lid. Alternatively, the lid may have pre-formed weaknesses, such as perforations 34 which reduce the force required to open it.

In this case, the member 40 can be blunt, for example a wire. Preferably the member is angled or has a sloped part 41 so that as it moves into the capsule, the flap formed by opening the lid is pushed away from the opening and held out of the way whilst the tea material is released from the capsule.

In the preferred embodiment shown in FIG. 9, a second opening for introducing liquid into the capsule is made by pushing the lid against a static needle 42 consisting of a tube with a pointed end. The needle 42 pierces the lid. Water is then pumped from the reservoir to the heater, which is preferably a flow-through heater. The resulting hot water (and optionally steam) is then pumped to the capsule and enters it through the needle. The influx of hot water pushes the tea material out from the capsule through the opening made by the opening member 40 and into the infusion chamber 10.

The heater and pump are controlled so that the target brew temperature (which is typically in the range 80° C. to 95° C.) is achieved in the infusion chamber. Typically the water flow rate is in the range of 200 to 400 ml/min, and the volume of water is 150 to 300 ml, depending on the desired size of the beverage.

Preferably the infusion chamber 10 is made of transparent material such as glass, or transparent plastic, so that the user can see the motion of the tea material (such as tea leaves) whilst the beverage is brewing. Most preferably, the infusion chamber is made of Tritan™ copolyester because this material is transparent and has been found to have good resistance to staining. Air may be pumped into the capsule holder 20 (e.g. via the static needle) or directly into the infusion chamber 10 to create bubbles in the water and thereby agitate the tea material. This not only enhances the visual appearance, but also aids infusion and helps to prevent the tea material from sticking to the sides of the infusion chamber. Moreover, the introduction of air releases aroma which can optionally be vented via a tube, which for example, has an outlet near to the dispensing spout or near the top of the infusion chamber, thereby providing the user with the aroma of tea during brewing. The brewing time, which typically ranges from 10 to 120 seconds, is preferably set by user input and/or information read from the capsule.

Once brewing has taken place for the required time, the drain valve 21 located in the base of the capsule holder 20 is opened, allowing the beverage to drain from the infusion chamber. Preferably the opening of the drain valve is controlled automatically by the machine. The beverage flows from the infusion chamber through the filter 25 located in the capsule holder below the capsule, through the passage 29, and finally into a cup 9 which the user has already placed onto the tray 8. Tea material is prevented from entering the cup 9 by the filter 25.

Optionally, there may be a dispensing spout 7 positioned beneath the capsule holder as shown in FIG. 1, so that the beverage is dispensed through the drain valve and out through the spout. Thus, instead of being dispensed vertically downwards into the receptacle, the beverage follows an arc, similar to that of tea poured from the spout of a tea pot. This enhances the “theatre” provided by the machine for the user, and also emphasizes the “tea-ness” of the beverage, as distinct from coffee making machines.

After the beverage has been dispensed, the spent tea material may be rinsed from the wall of the brew chamber with further hot water. Preferably the rinsing water is introduced through rotating rinse jets 18 located near the top of the infusion chamber. Better rinsing is achieved by rotating rinse jets than static ones. In a preferred embodiment, rinsing takes place immediately after the beverage has been dispensed, and the rinse water is also dispensed into the receptacle and becomes part of the beverage. This removes the need for separate disposal of the rinse water. In this case, the rinse water provides around 15-30% of the total volume of the beverage, e.g. the volume of rinse water used is around 50 ml.

Finally, after the beverage has been dispensed, the capsule holder is lowered, preferably automatically, or alternatively by the user, for example by activating a button. The user then removes the capsule holder from the support, using the handle 22, or in the second embodiment of the capsule holder shown in FIG. 6, the user may just remove the strainer from the receptacle. The used capsule and spent tea leaves are then disposed of, and the capsule holder can be rinsed.

Since the capsule holder is removable from the brewing device, it is easy to clean. The capsule holder is then returned to the support, ready for the next use.

The device can be cleaned, for example by running a rinse cycle with no tea material or by running a cycle with a cleaning material, for example sodium percarbonate. The cleaning material can be provided in a capsule, or alternatively as a tablet which is simply placed in the capsule holder.

The various features of the embodiments of the present invention referred to in individual sections above apply, as appropriate, to other sections mutatis mutandis. Consequently features specified in one section may be combined with features specified in other sections as appropriate. Various modifications of the described modes for carrying out the invention which are apparent to those skilled in the relevant fields are intended to be within the scope of the following claims.

1. An automated beverage brewing device (1) comprising an infusion chamber (10), at the base of which is a capsule holder for supporting a capsule comprising infusible material, means for introducing liquid into the capsule so that the liquid and tea material can mix and flow into the infusion chamber so as to brew the beverage, a filter (25) for permitting the passage of infused beverage but preventing the passage of unwanted solid particulate material, a chamber (70) beneath the filter (25) into which strained beverage passes during use, the chamber (70) having an outlet (21,29) for dispensing the prepared beverage characterized in that, the chamber (70) and the space above the filter (25) are in gaseous communication by means of at least one channel (27,76).

2. A capsule holder (20) for receiving a capsule (30) containing tea material, adapted for use with an automated beverage brewing device, the holder comprising a filter (25) for permitting the passage of prepared beverage but preventing the passage of unwanted coarse solid tea material, an inlet for receiving infused beverage above the filter, a means for supporting a capsule within the capsule holder, a chamber beneath the filter (25) into which strained beverage passes during use, the chamber having an outlet for dispensing the prepared beverage, characterized in that, the chamber and the space above the filter (25) are in gaseous communication by means of at least one channel.

3. A capsule holder according to claim 1, wherein the filter is not located in the capsule but is located in the capsule holder.

4. A capsule holder according to claim 2 which comprises a separable receptacle (70) and a strainer (72) in which the filter (25) is situated.

5. A strainer which is adapted to co-operate with a receptacle to form a capsule holder, the strainer comprising:
a base (73) and a rim (74),
means (28) for supporting a capsule (30) within the strainer, so that the capsule partially covers the area inside the rim, and
a filter (25) situated beneath the intended location of the capsule, and a channel in the rim (74) that provides gaseous communication between the receptacle and the space above the filter when placed on the receptacle.

6. The combination of a strainer (72) according to claim 13 and a capsule (30) containing tea material.

7. A brewing device, capsule holder or strainer according to claim 1 wherein the channel presents greater total fluid flow resistance than that provided by the filter (25).

8. A brewing device, capsule holder or strainer according to claim 1, wherein the at least one channel is dimensioned to be greater than an opening in the filter, whilst still presenting greater total fluid resistance than the filter.

9. A brewing device, capsule holder or strainer according to claim 1, wherein the channel opening is above the filter surface.

10. A brewing device, capsule holder or strainer according to claim 7, wherein the opening is at least 5 mm above the filter, preferably at least 10 mm above.

11. A brewing device, capsule holder or strainer according to claim 1, which comprises no more than five channels, preferably no more than three or even only one channel.

12. A brewing device, capsule holder or strainer according to claim 1, wherein the channels have an effective cross sectional diameter of from 0.5 to 4 mm, preferably from 1.0 to 2.0 mm.

13. A brewing device, capsule holder or strainer according to claim 1, wherein the channel opening above the filter is located downstream of the filter surface in use.

14. A brewing device, capsule holder or strainer according to claim 12 wherein, in use, the infused beverage flows onto a first side of the filter, with the opening of the channel being positioned opposite the first side of the filter.

15. A brewing device, capsule holder or strainer according to claim 13, wherein the presence of the capsule directs the infused beverage onto the first side of the filter, whereupon the infused beverage must flow over the filter surface beneath the capsule before reaching the opposite side of the filter surface before reaching the opening of the channel above the filter.
